(19) United States
(12) Patent Application Publication
(10) Pub. No.: US 2011/0063225 A1
(43) Pub. Date: Mar. 17, 2011

(54) User Interface for Handheld Electronic Devices

(76) Inventor: Louis Michon, Gatineau (CA)

(21) Appl. No.: 12/549,808

(22) Filed: Aug. 28, 2009

(51) Int. Cl. G06F 3/02

(52) U.S. Cl. 345/169

(57) ABSTRACT

A keypad-based alphanumeric user interface, data entry process and method specifically designed for thumb typing on a handheld electronic device, with a left-thumb/right-thumb accessible and symmetrical key distribution of consonant letters placed in alphabetical order on a six columns/six rows square-shaped surface, omitting all vowels in some key distribution mode (e.g., default and SHIFT modes), and offering the option of replacing some or all said vowels in any word with a generic vowel mark instead of any specific vowel.

### FIELD OF INVENTION

The present invention relates to a handheld computer device, and more specifically to a user interface, data entry process and method for handheld electronic devices in the form of an alphanumeric keypad to input letters, numbers and characters in said handheld electronic device.

### BACKGROUND OF THE INVENTION

Ever since the invention of the typewriter and, later, with the invention of the touch-tone telephone technology, methods and processes for data entry through a keyboard or a keypad have been developed. The most lasting and most widely used alphanumeric keyboard design is the Sholes QWERTY keyboard, patented in 1878 in the United States by C. L. Sholes.

Key distribution in the QWERTY keyboard was designed to avoid the most frequently-used letters in English from being too close from one another to avoid their typebars to cross paths and become entangled. The QWERTY keyboard design became an industry norm.

In 1962, IBM created and marketed the Selectric typewriter, which, with its new typeball improvement, made the old typebar typewriters obsolete. Even though the IBM typeball resolved the issue of typebar entanglement, the QWERTY keyboard design was kept because it was a well-established industry norm.

The QWERTY keyboard successfully made the transition to the Computer Age in the late 1970s and remained the industry norm for personal computer keyboards.

More recently, when handheld electronic devices became available in the 1990s, while the traditional 12-key telephone alphanumeric keypad was used for earlier generation cell phones, QWERTY was adopted for the newer ‘smart phones’ with more advanced text and e-mail functions.

However, both the 12-key telephone alphanumeric keypad and the QWERTY keypad are not well adapted for alphanumeric data entry on a handheld electronic device. Text and data entry with a 12-key telephone alphanumeric keypad is extremely slow and cumbersome, requiring between one and nine keystrokes to enter a single letter, digit or character.

Furthermore, the fact that the handheld electronic device must be held in one or both hands, and the much smaller surface allowed for key distribution, forbid the true QWERTY typing technique, making it obsolete for handheld electronic devices. QWERTY is a 10-finger reflex-based typing system and method impossible to fully operate efficiently on a handheld electronic device. Users must revert to ‘thumb typing’ or to one-finger typing on such handheld electronic devices, either directly with their thumbs or fingers, or through the intermediary of a stylus.

Several improvements have been conducted to provide keypads for handheld electronic devices. However, most of them were variants of the 10-key wide QWERTY design or of the 12-key alphanumeric telephone keypad, which are not easily operated on handheld devices.

### SUMMARY OF THE INVENTION

It is an object of the invention to provide a method and system that obviates or mitigates at least one of the disadvantages of existing systems.

In according to one embodiment of the present invention there is provided a user interface for a handheld computer system, which includes: an input device having a plurality of key positions in a key area and a first key distribution applied to the key positions, the first key distribution having: a first group of keys assigned to a first group of the plurality of key positions, associated with a first type of consonant letters in a first mode; and a second group of keys assigned to a second group of the plurality of key positions, including a vowel mark key for inserting a default mark for a vowel letter.

In according to one embodiment of the present invention there is provided a user interface for a handheld computer device, which includes: an input device having a plurality of key positions in a key area and a first key distribution applied to the key positions, the first key distribution having: a first group of keys assigned to a first group of the plurality of key positions, associated with a first type of consonant letters in alphabetical order, in a first mode, the first group of keys being symmetrically distributed about a center vertical axis of the key area.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 is a schematic diagram illustrating a default mode key distribution of a CONVOY keypad for touch screen.

FIG. 2 is a schematic diagram illustrating a shift mode key distribution of the CONVOY keypad for touch screen.

FIG. 3 is a schematic diagram illustrating an alt mode key distribution of the CONVOY keypad for touch screen.

FIG. 4 is a schematic diagram illustrating a default mode key function distribution of a CONVOY hard-key keypad.

FIG. 5 is a schematic diagram illustrating a shift mode key function distribution of the CONVOY hard-key keypad.

FIG. 6 is a schematic diagram illustrating an alt mode key function distribution of the CONVOY hard-key keypad.

FIG. 7 is a schematic diagram illustrating the CONVOY hard-key keypad (three modes markings).

FIG. 8 is a schematic diagram illustrating an example of a handheld electronic device implementing a key distribution of FIGS. 1-3 or 4-7.

### DETAILED DESCRIPTION

Embodiments of the present invention provide a CONVOY keypad user interface and data entry method which is specifically designed for thumb typing on handheld electronic devices. In one example, the CONVOY keypad user interface is provided with a touch screen keypad. In another example, the CONVOY keypad user interface is provided with a hard-key keypad. The term CONVOY is based on the contraction of two French words: consonne (consonant) and voyelle (vowel), and underlines one of the features of the embodiments of this invention, that of the strategic use and distribution of consonants and vowels on the keypad to accelerate and facilitate data entry on a handheld electronic device. The term CONVOY is used as an abbreviation for increased clarity of the embodiments and encompasses the novel and specific keypad design and the data entry method.

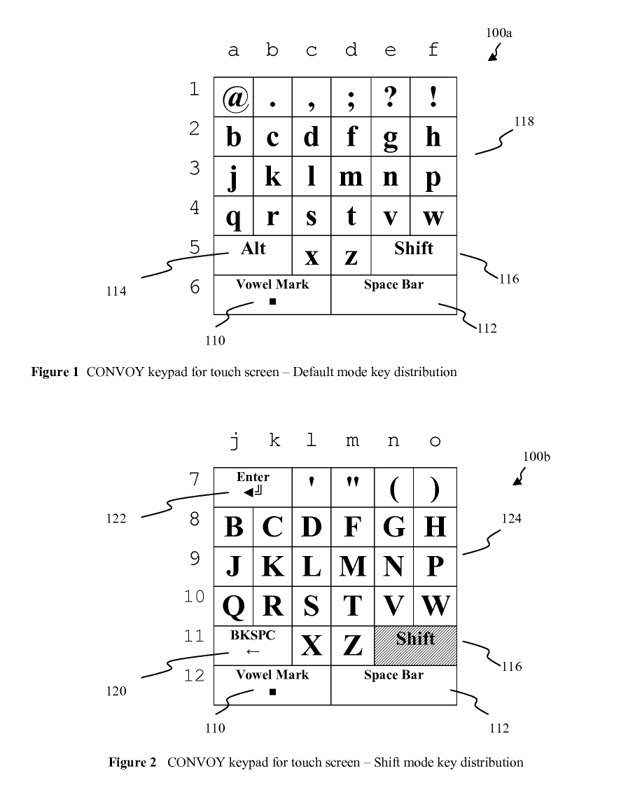

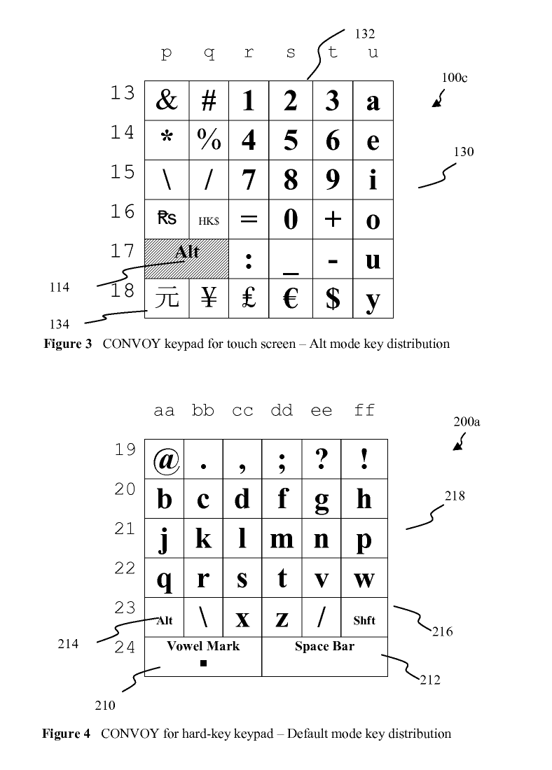

Referring to FIGS. 1-3, there are shown a default mode key distribution, a shift mode key distribution, and an alt mode key distribution in a CONVOY keypad for a touch screen, respectively. In this example, the key area is square-shaped with 6*6 (=36) key positions. “a” to “f” and “1” to “6” denoted outside the key layout 100a of FIG. 1 represent key positions in the default mode. “j” to “o” and “7” to “12” denoted outside the keyboard layout 100b of FIG. 2 represent key positions in the shift mode. “p” to “u” and “13” to “18” denoted outside the keyboard layout 100c of FIG. 3 represent key positions in the alt mode. One of ordinary skill in the art would understand that the key positions of FIGS. 1-3 are associated with each other.

A specific function is allocated to a key position in dependence upon a key distribution mode (default, shift and alt modes), as described below. In the description, “(key) layout”, “(key) distribution”, “(key) function distribution”, and “(key) function layout” may be used interchangeably.

In the default mode, the CONVOY key layout 100a defines thirty (30) keys in the key area, including a vowel mark 110, a space bar 112, an alt 114, a shift 116, and lower-case consonant letters 118. In the shift mode, the key layout 100b is allocated to the key area. The key layout 100b defines thirty (30) keys, including the vowel mark 110, the space bar 112, the shift 116, a back space 120, and capital consonant letters 124. In the alt mode, the key layout 100c is allocated to the key area. The key layout 100c defines thirty five (35) keys, including the alt 114, vowels 130, numeral digits 132, and currency symbols 134.

In this example, the alt key 114 is replaced with the back space 120 when switching the default mode to the shift mode. In this example, the vowel mark 110, the space bar 112 and the shift 116, two consonant letters “x”, and “z” are replaced with other keys when switching the default mode to the alt mode.

In one example, the shift key 116 is placed so as to be easily operated by one thumb (e.g., right thumb) and the alt key 114 is placed so as to be easily operated by the other thumb (e.g., left thumb). In the shift mode, frequently used keys are placed opposite the shift key 116, allowing their easy input by the other thumb (e.g., left thumb), such as enter key 122, the back space key 120 and the vowel mark key 110. In the alt mode, frequently used keys are replaced opposite the alt key 114, allowing their easy input by the other thumb (e.g., right thumb), such as vowel keys (e.g., a, e, I, o, u, y) and numeral digits (e.g., 1, 2, 3, 4, 5, 6, 7, 8, 9, and 0).

The vowel mark 110 is a general mark key for inserting a general (default) mark, rather than a specific vowel character, as described below. In this example, the key distribution layout 100a and 100b use the same vowel mark 110; however, in each mode, a different vowel mark may be used.

In the default mode, the alt key 114 and the shift key 116 may be used to change (alternate) the function of other pressed keys as well understood by one of ordinary skill in the art.

The CONVOY keypad has a six columns/six rows key distribution design (FIG. 1) allowing for larger keys, simpler key choices and a square-shaped key distribution surface more adapted to handheld electronic devices than the horizontal oblong QUERTY design (landscape style) required by the 10-key wide QUERTY key distribution design.

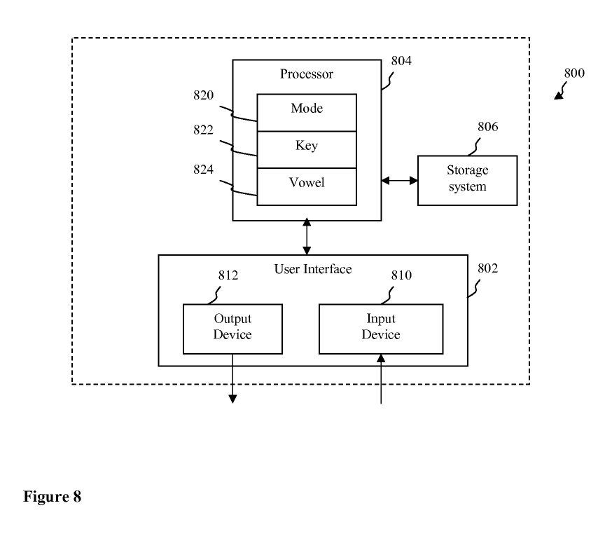

The CONVOY keypad's default and SHIFT modes require a lesser number of keys than the QUERTY design because all the vowels in the Roman alphabet are omitted in both the CONVOY key distribution design (default mode—FIG. 1 and SHIFT mode—FIG. 2) and in the data entry method. In these two CONVOY key distribution designs and data entry modes (FIG. 1 and FIG. 2), the handheld electronic device (e.g., 800 of FIG. 8) user can type a generic ‘Vowel Mark’ (e.g., 110) to mark the vowels in a word. The Vowel Mark key is an innovation specific to the embodiments of this invention.

The CONVOY keypad and data entry method leave the task of finding which vowels are missing to an enhanced spelling and grammar correction software, also known as disambiguation software. This supporting software may be a typical lexicon and grammar rules-based word and sentence correction software. This type of software is widely used and included with handheld electronic devices designed for data entry and transmission. However, the software module (e.g., modules 804 of FIG. 8) is sophisticated enough to recognize the ‘consonant infrastructure’ of words and to use vowel marks inputted by the CONVOY keypad and data entry method as hints to eliminate redundancy or ambiguity between words having a similar consonant infrastructure.

The CONVOY keypad and data entry method is based on a fundamental linguistic principle common to most Western (i.e. of European origin) languages using the Roman alphabet. This principle has not been widely-used in information technology until now and is crucial to the CONVOY keypad and data entry method.

The principle is that, in most Western (i.e. of European origin) languages using the Roman alphabet, consonant letters carry most of the information necessary for words to be understandable in written language while vowels are mostly essential in spoken language. The purpose of vowels in most Western (i.e. of European origin) spoken languages is to allow the speaker to create what woodwind musicians call a ‘column of air’ which surrounds the expression of consonants when the speaker creates obstacles to this air flow with his/her tongue, teeth and lips. In most Western-world spoken languages, expressed vowels create the general environment of a spoken word while consonants characterize the specific meaning of the word. This principle means that vowels are much less essential in a written word than in a spoken word. This is the premise on which the CONVOY keypad and data entry method is based.

In a written text, a sequence of consonant letters forms the infrastructure of a word and carries most of the information of said word. If vowels are omitted in data entry, the level of information conveyed by a word increases in a direct proportion with the number of consonants placed in a sequence in said word (an infrastructural word). The more consonants in a word, the higher the discrimination will be between words of similar infrastructure and the lesser the possibility of redundancy or ambiguity. In the same way, the level of information conveyed by a sentence increases directly with the number of infrastructural words placed in a sequence (an infrastructural sentence).

Furthermore, the input of a generic vowel mark (e.g., 110 of FIGS. 1-2) instead of specific vowels, as allowed by this CONVOY, to replace some or all the vowels in a word, is sufficient to increase the typed information of said infrastructural words and sentences to a level of comprehension or meaning recognizable by most readers and by most word-recognition software.

In one embodiment, the CONVOY ALT keypad mode functions in the following fashion on a touch screen operated handheld electronic device (see FIGS. 1 and 3):

I. a touch and release of the ALT key (114) locks in ALT keypad mode (FIG. 3)

II. a subsequent touch and release of the ALT key (114) while locked in ALT mode unlocks the ALT mode and returns to the default keypad (FIG. 1)

III. a constant touch of the ALT key (114) while striking other ALT mode letter or character keys inputs the code controlled by said keys while the subsequent release of the ALT key brings back the default keypad (FIG. 1).

In one embodiment, the CONVOY SHIFT keypad mode functions in the following fashion on a touch screen operated handheld electronic device (see FIGS. 1 and 2):

IV. a touch and release of the SHIFT key (116) locks in the SHIFT keypad mode (FIG. 2)

V. a subsequent touch and release of the SHIFT key (116) while locked in SHIFT mode unlocks the SHIFT mode and returns to the default keypad (FIG. 1)

VI. a constant touch of the SHIFT key (116) while striking other SHIFT mode letter or character keys inputs the code controlled by said keys while the subsequent release of the SHIFT key brings back the default keypad (FIG. 1).

In one embodiment, the CONVOY keypad and data entry method brings the following improvements to previous handheld data entry methods such as the QWERTY design and method and the 12-key alphanumeric telephone keypad for touch screen operated handheld electronic devices:

A. In one example, there is provided a key distribution specifically designed for thumb typing on a touch screen operated handheld electronic device, featuring:

1. A lesser number of key choices than the QWERTY keypad in default and SHIFT modes (FIGS. 1 and 2) allowing larger key sizes more adapted to thumb typing;

2. A larger key size allowed by totally omitting vowels in the default mode (FIG. 1) and SHIFT mode (FIG. 2) key distribution, presenting a key size more adapted to the larger width of the thumb compared to the size of other fingers in a human hand;

3. The symmetrical key distribution of an even number of keys on both sides of a centered vertical axis in the default and SHIFT modes (FIGS. 1 and 2), allowing a similar reach and the same number of key choices and key sizes for both thumbs;

4. A cluster of ten consonant letters centered around lower case consonant letter k (default mode, FIG. 1) and capital letter K (SHIFT mode, FIG. 2), to be operated by the left thumb;

5. A centered consonant letter, lower-case letter k (default mode, FIG. 1) and capital letter K (SHIFT mode, FIG. 2), as a basic reference position for the left thumb, allowing the reflex-based typing and learning of triads of letters k c k, k-r-k, k-b-k; k-s-k, k-d-k, k-q-k, k-j-k, k-l-k and k-x-k, in a fashion typical to typing tutor methods, and specific to a thumb typing method allowed by the CONVOY keypad and data entry method;

6. A cluster of ten consonant letters centered around lower case consonant letter n (default mode, FIG. 1) and capital letter N (SHIFT mode, FIG. 2), to be operated by the right thumb;

7. A centered consonant letter, lower-case letter n (default mode, FIG. 1) and capital letter N (SHIFT mode, FIG. 2), as a basic reference position for the right thumb, allowing the reflex-based typing and learning of triads of letters n-g-n, n-v-n, n-f-n, n-w-n, n-h-n, n-t-n, n-z-n, in a fashion typical to typing tutor methods and specific to a thumb typing method allowed by the CONVOY keypad and data entry method;

8. The presence of a generic Vowel Mark key (110) placed symmetrically opposite to the Space Bar (112), the Vowel Mark key being operated by the left thumb and the Space Bar being operated by the right thumb (FIGS. 1 and 2);

9. The use of a generic Vowel Mark (110) to replace some or all the vowels in a typed word, allowing the omission of all vowels in default and SHIFT mode typing and key distribution (FIGS. 1 and 2);

10. The symmetrical opposition of the two statistically most frequently used keys in CONVOY data entry, namely the Vowel Mark and the Space bar (110 and 112 of FIGS. 1 and 2) easing the alternating or consecutive use of both keys by each thumb;

11. The largest size (three column-wide) allowed to the two statistically most frequently used keys in CONVOY data entry, namely the Vowel Mark and the Space bar (110 and 112 of FIGS. 1 and 2);

12. The most reachable key positions by the thumbs—bottom left and bottom right—allowed to the two statistically most frequently used keys in CONVOY data entry (110 and 112 of FIGS. 1 and 2);

13. More frequently used keys are placed opposite to the ALT key (114) when the ALT key is pressed down by the left thumb to activate the ALT mode and/or keypad, allowing their easy input by the right thumb, such as the six vowel keys a, e, o, u, y (130); numeral digits 1, 2, 3, 4, 5, 6, 7, 8, 9 and 0 (132); and currency symbols $, [symbol] and £ (134) in ALT mode (FIG. 3);

14. More frequently used keys are placed opposite to the SHIFT key (116) when the SHIFT key is pressed down to activate the SHIFT mode and/or keypad, allowing their easy input by the left thumb, such as the Enter key (122), the Backspace key (120) and the Vowel Mark key (110) (FIG. 2);

B. In one example, there is provided faster data entry on a touch screen operated handheld electronic device with:

15. The total omission of vowel keys in default (FIG. 1) and SHIFT (FIG. 2) mode key distribution allowing a lesser number of key choices than the QWERTY keypad in default and SHIFT modes;

16. The presence and optional use of a generic Vowel Mark key (110 of FIGS. 1, 2 and 3) to replace some or all the vowels while typing words, allowing the partial or total omission of specific vowel input when typing in default mode, SHIFT mode and ALT mode;

17. The inclusion of vowels in a convenient right-thumb operated position in ALT mode, opposed to the left-thumb operated ALT key and mode (FIG. 3) because, even though text and data entry with the CONVOY keypad and data entry method do not require the entry of specific vowels, said specific vowels are essential to type full e-mail addresses, URLs, web site names, domain names and other functions performed by handheld electronic devices;

18. An alphabetical distribution of all consonant keys (118 and 124) on 20 successive keys, from b to z, successively disposed on six columns and four rows, easing the user's visual search for a specific consonant key (FIGS. 1 and 2);

19. Some of the most frequently used keys by handheld electronic device users, such as @, and period sign are placed in the default keypad mode;

20. A larger key size allowed by totally omitting vowels in the default and SHIFT modes (FIGS. 1 and 2);

21. A symmetrical key distribution of an even number of keys on both sides of a centered vertical axis in the default and SHIFT modes (FIGS. 1 and 2);

22. A cluster of ten consonant letters centered around lower case consonant letter k (default mode) and capital letter K (shift mode), to be operated by the left thumb (FIGS. 1 and 2);

23. A centered consonant letter, lower-case letter k (default mode) and capital letter K (shift mode), as a basic reference position for the left thumb, allowing the reflex-based typing and learning of triads of letters k c k, k-r-k, k-b-k; k-s-k, k-d-k, k-q-k, k-j-k, k-l-k and k-x-k, in a fashion typical to typing tutor methods, and specific to a thumb typing method allowed by the CONVOY keypad and data entry method (FIGS. 1 and 2);

24. A cluster of ten consonant letters centered around lower case consonant letter n (default mode) and capital letter N (shift mode), to be operated by the right thumb (FIGS. 1 and 2);

25. A centered consonant letter, lower-case letter n (default mode) and capital letter N (SHIFT mode), as a basic reference position for the right thumb, allowing the reflex-based typing and learning of triads of letters n-g-n, n-v-n, n-f-n, n-w-n, n-h-n, n-t-n, n-z-n, in a fashion typical to typing tutor methods and specific to a thumb typing method allowed by the CONVOY keypad design and data entry method (FIGS. 1 and 2);

26. The inclusion of a Vowel Mark key (110) placed symmetrically opposite to the Space Bar (112), the Vowel Mark key being operated by the left thumb and the Space Bar being operated by the right thumb (FIGS. 1 and 2);

27. The symmetrical opposition of the two statistically most frequently used keys in CONVOY data entry, namely the Vowel Mark and the Space bar (110 and 112 of FIGS. 1 and 2);

28. The largest size (three column-wide) allowed to the two statistically most frequently used keys in CONVOY data entry, namely the Vowel Mark and the Space bar (110 and 112 of FIGS. 1 and 2);

29. The most reachable key positions by the thumbs—bottom left and bottom right—allowed to the two statistically most frequently used keys in CONVOY data entry (FIGS. 1 and 2);

30. More frequently used keys are placed opposite to the ALT key (114) when the ALT key is pressed down by the left thumb to activate the ALT mode and/or keypad, allowing their easy input by the right thumb, such as the six vowel keys a, e, o, u, y (130); numeral digits 1, 2, 3, 4, 5, 6, 7, 8, 9 and 0 (132); and currency symbols $, [symbol] and £ (134) (FIG. 3);

31. More frequently used keys are placed opposite to the SHIFT key (116) when the SHIFT key is pressed down by the right thumb to activate the SHIFT mode and/or keypad, allowing their easy input by the left thumb, such as the Enter key (122), the Backspace key (120) and the Vowel Mark key (110) (FIG. 2);

32. The use of a generic vowel mark (110) to bring the level of information of a typed word to a level of comprehension or meaning recognizable by most readers and by most word-recognition software (FIGS. 1, 2 and 3).

C. In one example, there is provided a reduction of entered data volume on a touch screen operated handheld electronic device by:

33. Omitting some or all vowels in word input and replacing some or all vowels by a generic vowel mark (FIGS. 1, 2 and 3).

D. In one example, the same keypad for a touch screen is operated on a handheld electronic device, with an array of keys representing characters of the roman alphabet, numbers, punctuation signs, international Unicode characters and control keys wherein the array includes six columns and six rows and where the default mode (FIG. 1) has thirty (30) keys, defined as:

34. (FIG. 1, key positions a-1 to f-1) the top row of six keys in default mode identified to and controlling the input of, from left to right, punctuation sign @ known as commercial at, occupying position a-1 in FIG. 1; punctuation sign. known as period, occupying position b-1 in FIG. 1; punctuation sign, known as comma, occupying position c-1 in FIG. 1; punctuation sign; known as semi-colon, occupying position d-1 in FIG. 1; punctuation sign ? known as interrogation mark, occupying position e-1 in FIG. 1; punctuation sign ! known as exclamation mark, occupying position f-1 in FIG. 1.

35. (FIG. 1, key positions a-2 to f-2) the second row of six keys in default mode identified to and controlling the input of, from left to right, lower case consonants b, c, d, f, g, h;

36. (FIG. 1, key positions a-3 to f-3) the third row of six keys in default mode identified to and controlling the input of, from left to right, lower case consonants j, k, l, m, n, p;

37. (FIG. 1, key positions a-4 to f-4) the fourth row of six keys in default mode identified to and controlling the input of, from left to right, lower case consonants q, r, s, t, v, w

38. (FIG. 1, key positions a-5 to f-5) the fifth row from the top in default mode, identified to and controlling the input of, from left to right, the ALT mode (key 114) with a double-width key occupying positions a-5 and b-5 in FIG. 1; lower case letter X occupying position c-5 in FIG. 1; lower case letter Z occupying position d-5 in FIG. 1; and the SHIFT mode (key 116) with a double-width key occupying positions e-5 and f-5 in FIG. 1.

39. (FIG. 1, key positions a-6 to f-6) the sixth row from the top in default mode, identified to and controlling the input of, from left to right, a ‘vowel mark’ (key 110) with a triple-width key identified as VOWEL MARK and showing the symbol ▪ occupying positions a-6, b-6 and c-6 in FIG. 1; and a single space with a triple-width identified as SPACE BAR (key 112) and occupying positions a-6, b-6 and c-6 in FIG. 1.

E. In one example, the same keypad for a touch screen is operated on a handheld electronic device wherein the SHIFT mode presents an array of six columns and six rows and where the SHIFT mode becomes functional when the SHIFT key (116) is pressed down to activate twenty-nine (29) keys in SHIFT mode (FIG. 2) replacing the default mode keys.

40. (FIG. 2, key positions j-7 to o-7) the first row from the top in SHIFT mode having five keys identified to, and controlling the input of, from left to right, a key occupying two columns identified as ENTER (122), a key occupying a single column identified to and activating punctuation sign ' known as apostrophe, a key occupying a single column identified to and activating punctuation sign “ known as quotation mark, a key occupying a single column identified to and activating the input of punctuation sign (known as left parenthesis, a key occupying a single column identified to and activating the input of punctuation sign) known as right parenthesis.

41. (FIG. 2, key positions j-8 to o-8) the second row from the top in SHIFT mode having six keys identified to, and controlling the input of, from left to right, upper case consonants B, C, D, F, G, H;

42. (FIG. 2, key positions j-9 to o-9) the third row from the top in SHIFT mode identified to, and controlling the input of, from left to right, upper case consonants J, K, L, M, N, P

43. (FIG. 2, key positions j-10 to o-10) the fourth row from the top in SHIFT mode identified to, and controlling the input of, from left to right, upper case consonants Q, R, S, T, V, W

44. (FIG. 2, key positions j-11 to o-11) the fifth row from the top in SHIFT mode identified to, and controlling the input of, from left to right, a key occupying two columns identified as BCKSPC (120), a key occupying a single column identified to and controlling the input of capital letter X, a key occupying a single column identified to and controlling the input of capital letter Z and a key occupying two columns identified as SHIFT (116) and controlling the activation of the SHIFT mode keypad (FIG. 2)

45. (FIG. 2, key positions j-12 to o-12) the sixth row from the top in SHIFT mode identified to, and controlling the input of, from left to right, a key occupying three columns identified as VOWEL MARK (110), showing the symbol ▪ and controlling the input of a generic vowel mark and a key occupying three columns identified as SPACE BAR (112) and controlling the input of a single space.

F. In one example, the same keypad for a touch screen is operated on a handheld electronic device wherein the array includes six columns and six rows where the ALT mode becomes functional when the ALT key (114) is pressed down and activates twenty-nine (29) keys (FIG. 3), namely:

46. (FIG. 3, key positions u-13 to u-18) in the sixth column from the left in ALT mode, six keys identified to, and controlling the input of, from the top row to the bottom row, lower case vowels a, e, i, o, u, y;

47. (FIG. 3, key positions t-13 to t-18) in the fifth column from the left in ALT mode, six keys from the top row to the bottom row identified to, and controlling the input of, numbers 3, 6, and 9, the + sign known as ‘plus’, the − sign known as hyphen or minus sign, and the $ sign known as the dollar currency symbol;

48. (FIG. 3, key positions s-13 to s-18) in the fourth column from the left in ALT mode, six keys from the top row to the bottom row, identified to, and controlling the input of numbers 2, 5, 8, 0, the _ sign known as ‘underscore’ and the [symbol] sign known as the Euro currency symbol (or another user-programmable international Unicode character);

49. (FIG. 3, key positions r-13 to r-18) in the third column from the left in ALT mode, six keys from the top row to the bottom row identified to, and controlling the input of numbers 1, 4 and 7, the = sign known as equals symbol, the : sign known colon and the £ sign known as the pound currency symbol (or another user-programmable international Unicode character);

50. (FIG. 3, key positions q-13 to q-18) in the second column from the left in ALT mode, six keys from the top row to the bottom row identified to, and controlling the input of the # sign also known as number sign, the % sign known as the percent symbol, the / sign also known as the solidus or slash symbol, the HK$ sign known as Hong Kong dollar symbol (or another user-programmable international Unicode character), the right half of the ALT key (114) and the ¥ sign known as the yen currency symbol (or another user-programmable international Unicode character).

51. (FIG. 3, key positions p-13 to p-18) in the first column from the left in ALT mode six keys from the top row to the bottom row identified to, and controlling the input of the & sign known as the ampersand, the * sign known as the asterisk, the \ sign known as the reverse solidus or backslash, the [symbol] sign known as the Indian rupee currency symbol (or another user-programmable international Unicode character), the left half of the ALT key (114) and the [symbol] sign known as the Chinese Yuan currency symbol (or another user-programmable international Unicode character).

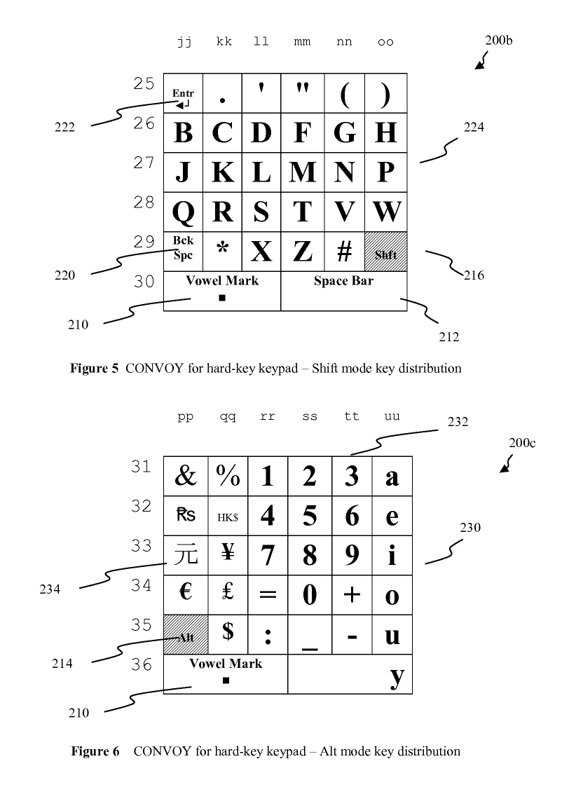

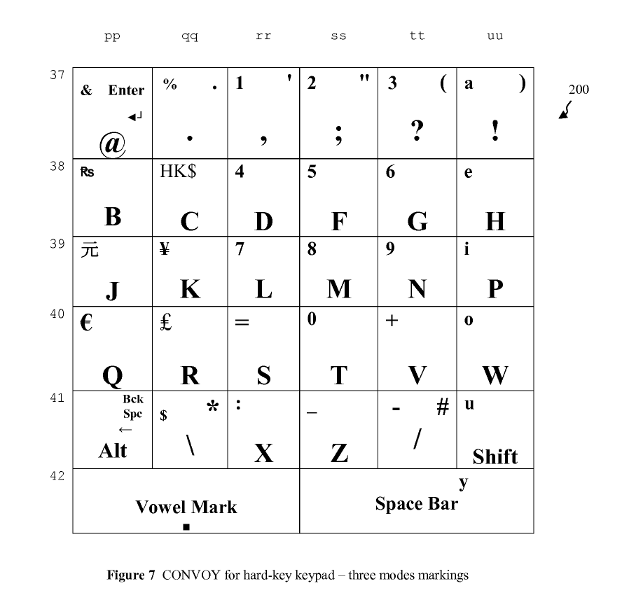

Referring to FIG. 7, there is shown a key distribution in a CONVOY hard-key keypad. FIGS. 4-6 schematically illustrate the function of the CONVOY hard-key keypad 200 of FIG. 7, in a default mode, a shift mode, and an alt mode, respectively. In this example, the key area is square-shaped with 6*6 (=36) key positions and has 32 keys. “aa” to “ff” and “19” to “24” denoted in FIG. 4 represent key positions in the default mode. “jj” to “oo” and “25” to “30” denoted in FIG. 5 represent key positions in the shift mode. “pp” to “uu” and “31” to “36” denoted in FIGS. 6 and 7 represent key positions in the alt mode. One of ordinary skill in the art could understand that the key positions of FIGS. 4-7 are associated with each other.

The CONVOY key layout 200 has 32 physical keys, some of them have multi functions. For example, the key at “pp” and “41” may be a back space key or an alt key. A specific function is allocated to a key in dependence upon a key (function) distribution mode (default, shift and alt modes), as described below.

In the default mode, the key function layout 200a of FIG. 4 is allocated to the key area, which includes a vowel mark 210, a space bar 212, an alt 214, a shift 216, and lower-case consonant letters 218. In the shift mode, the key function layout 200b of FIG. 5 is allocated to the key area, which includes the vowel mark 210, the space bar 212, the shift 216, capital consonant letters 224, and a back space 220. In the alt mode, the key function layout 200c of FIG. 6 is allocated to the key area, which includes the alt 214, vowel characters 230, numeral digits 232, and currency symbols 234.

In one example, the shift key 216 is placed so as to be easily operated by one thumb (e.g., right thumb) and the alt key 214 is placed so as to be easily operated by the other thumb (e.g., left thumb). In the shift mode, frequently used keys are replaced opposite the shift key 216, allowing their easy input by the other thumb (e.g., left thumb), such as enter key 222, the back space key 220 and the vowel mark key 210. In the alt mode, frequently used keys are replaced opposite the alt key 214, allowing their easy input by the other thumb (e.g., right thumb), such as vowel keys (e.g., a, e, I, o, u, y) and numeral digits (e.g., 1, 2, 3, 4, 5, 6, 7, 8, 9, and 0).

The vowel mark 210 is a general mark key for inserting a general default) mark, rather than a specific vowel character, as described below. In this example, the key layout 200a and 200b use the same vowel mark 210; however, in each mode, a different vowel mark may be used. In this example, the key layout 200c has the vowel mark 210; however, it may have another key(s) rather than the vowel mark 210.

In the default mode, the alt key 214 and the shift key 216 may be used to change (alternate) the function of other pressed keys as well understood by one of ordinary skill in the art.

G. In one example, there is provided a key distribution specifically designed for thumb typing on hard-keypad operated handheld electronic devices (FIGS. 4, 5, 6 and 7) featuring a six columns/six rows key distribution design (FIGS. 4, 5, 6 and 7) allowing for larger keys, simpler key choices and a square-shaped key distribution surface more adapted to vertical-shaped handheld electronic devices than the horizontal oblong QUERTY design (landscape style) required by the 10-key wide QUERTY key distribution design. The default mode letters (lower case consonant letters) and capital consonant letters are marked in a centered position in the lower half of the hard keys (FIG. 7) where in the default mode, lower case consonant letters are activated. The SHIFT mode letters and symbols are marked on the upper right side of the hard keys and reduced to at least one-third the size of default mode letters and symbols (FIG. 7). The ALT mode letters are marked on the upper left side of the hard keys, reduced to at least one-third the size of default mode letters (FIG. 7). All consonants keys are marked in capitals only (224 of FIGS. 5 and 7); all vowels keys are marked in lower case only (230 of FIG. 6); consonant keys in the default mode for the hard-key CONVOY keypad (FIG. 4) activate the lower case consonants (218), although for the sake of key readability, only the capital consonants are identified on the hard keys; capital consonants (224) are entered by using the SHIFT mode (FIG. 5).

In one embodiment, the CONVOY ALT keypad mode functions in the following fashion on a hard-keypad operated handheld electronic device (see FIGS. 4, 6 and 7):

I. a touch and release of the ALT key (214) locks in ALT keypad mode.

II. a subsequent touch and release of the ALT key (214) while locked in ALT mode unlocks the ALT mode and returns to the default keypad.

III. a constant touch of the ALT key (214) while striking other ALT mode letter or character keys inputs the code controlled by said keys while the subsequent release of the ALT key brings back the default keypad.

In one embodiment, the CONVOY SHIFT keypad mode functions in the following fashion on a hard-keypad operated handheld electronic device (see FIGS. 4, 5 and 7):

IV. a touch and release of the SHIFT key (216) locks in the SHIFT keypad mode.

V. a subsequent touch and release of the SHIFT key (216) while locked in SHIFT mode unlocks the SHIFT mode and returns to the default keypad.

VI. a constant touch of the SHIFT key (216) while striking other SHIFT mode letter or character keys inputs the code controlled by said keys while the subsequent release of the SHIFT key brings back the default keypad.

H. In one embodiment, the CONVOY keypad and data entry method brings the following improvements to previous handheld data entry methods such as the QWERTY method and the 12-key alphanumeric telephone keypad for hard-keypad operated handheld electronic devices:

I. In one example, there is provided a key distribution specifically designed for thumb typing on a hard-keypad operated handheld electronic device, featuring:

52. A lesser number of key choices than the QWERTY keypad in default and SHIFT modes (FIGS. 4 and 5) allowing larger key sizes more adapted to thumb typing;

53. A larger key size allowed by totally omitting vowels in the default mode (FIG. 4) and SHIFT mode (FIG. 5) key distribution, presenting a key size more adapted to the larger width of the thumb compared to the size of other fingers in a human hand;

54. The symmetrical key distribution of an even number of keys on both sides of a centered vertical axis in the default and SHIFT modes (FIGS. 4 and 5), allowing a similar reach and the same number of key choices and key sizes for both thumbs;

55. A cluster of ten consonant letters centered around lower case consonant letter k (default mode, FIG. 4) and capital letter K (SHIFT mode, FIG. 5), to be operated by the left thumb;

56. A centered consonant letter, lower-case letter k (default mode, FIG. 4) and capital letter K (SHIFT mode, FIG. 5), as a basic reference position for the left thumb, allowing the reflex-based typing and learning of triads of letters k c k, k-r-k, k-b-k; k-s-k, k-d-k, k-q-k, k-j-k, k-l-k and k-x-k, in a fashion typical to typing tutor methods, and specific to a thumb typing method allowed by the CONVOY keypad and data entry method;

57. A cluster of ten consonant letters centered around lower case consonant letter n (default mode, FIG. 4) and capital letter N (SHIFT mode, FIG. 5), to be operated by the right thumb;

58. A centered consonant letter, lower-case letter n (default mode, FIG. 4) and capital letter N (SHIFT mode, FIG. 5), as a basic reference position for the right thumb, allowing the reflex-based typing and learning of triads of letters n-g-n, n-v-n, n-f-n, n-w-n, n-h-n, n-t-n, n-z-n, in a fashion typical to typing tutor methods and specific to a thumb typing method allowed by the CONVOY keypad and data entry method;

59. The presence of a generic Vowel Mark key (210) placed symmetrically opposite to the Space Bar (212), the Vowel Mark key being operated by the left thumb and the Space Bar being operated by the right thumb (FIGS. 4 and 5);

60. The use of a generic Vowel Mark (210) to replace some or all the vowels in a typed word, allowing the omission of all vowels in default and SHIFT mode typing and key distribution (FIGS. 4 and 5);

61. The symmetrical opposition of the two statistically most frequently used keys in CONVOY data entry, namely the Vowel Mark and the Space bar (210 and 212 of FIGS. 4, 5 and 7) easing the alternating or consecutive use of both keys by each thumb;

62. The largest size (three column-wide) allowed to the two statistically most frequently used keys in CONVOY data entry, namely the Vowel Mark and the Space bar (210 and 212 of FIGS. 4, 5 and 7);

63. The most reachable key positions by the thumbs—bottom left and bottom right—allowed to the two statistically most frequently used keys in CONVOY data entry (FIGS. 4, 5 and 7);

64. More frequently used keys are placed opposite to the ALT key (214) when the ALT key is pressed down by the left thumb to activate the ALT mode and/or keypad, allowing their easy input by the right thumb, such as the six vowel keys a, e, i, o, u, y (230); numeral digits 1, 2, 3, 4, 5, 6, 7, 8, 9 and 0 (232); and currency symbols $, [symbol] and £ (234) in ALT mode (FIG. 6);

65. More frequently used keys are placed opposite to the SHIFT key (216) when the SHIFT key is pressed down to activate the SHIFT mode and/or keypad, allowing their easy input by the left thumb, such as the Enter key (222), the Backspace key (220) and the Vowel Mark key (210) (FIG. 5);

J. In one example, there is provided faster data entry on a hard-keypad operated handheld electronic device with:

66. The total omission of vowel keys in default (FIG. 4) and SHIFT (FIG. 5) mode key distribution allowing a lesser number of key choices than the QWERTY keypad in default and SHIFT modes;

67. The presence and optional use of a generic Vowel Mark (210 of FIGS. 4, 5, 6 and 7) key to replace some or all the vowels while typing words, allowing the partial or total omission of specific vowel input when typing in default mode, SHIFT mode and ALT mode;

68. The inclusion of vowels in a convenient right-thumb operated position in ALT mode, opposed to the left-thumb operated ALT key and mode (FIG. 5) because, even though text and data entry with the CONVOY keypad and data entry method do not require the entry of specific vowels, said specific vowels are essential to type full e-mail addresses, URLs, web site names, domain names and other functions performed by handheld electronic devices;

69. An alphabetical distribution of all consonant keys (218 and 224), on 20 successive keys from b to z, successively disposed on six columns and four rows, easing the user's visual search for a specific consonant key (FIGS. 4, 5 and 7);

70. Some of the most frequently used keys by handheld electronic device users, such as @ and period sign are placed in the default keypad mode (FIG. 4);

71. A larger key size allowed by totally omitting vowels in the default and SHIFT modes (FIGS. 4, 5 and 7);

72. A symmetrical key distribution of an even number of keys on both sides of a centered vertical axis in default and SHIFT modes (FIGS. 4, 5 and 7);

73. A cluster of ten consonant letters centered around lower case consonant letter k (default mode) and capital letter K (shift mode), to be operated by the left thumb (FIGS. 4, 5 and 7);

74. A centered consonant letter, lower-case letter k (default mode) and capital letter K (shift mode), as a basic reference position for the left thumb, allowing the reflex-based typing and learning of triads of letters k c k, k-r-k, k-b-k; k-s-k, k-d-k, k-q-k, k-j-k, k-l-k and k-x-k, in a fashion typical to typing tutor methods, and specific to a thumb typing method allowed by the CONVOY keypad and data entry method (FIGS. 4, 5 and 7);

75. A cluster of ten consonant letters centered around lower case consonant letter n (default mode) and capital letter N (shift mode), to be operated by the right thumb (FIGS. 4, 5 and 7);

76. A centered consonant letter, lower-case letter n (default mode, FIGS. 4 and 7) and capital letter N (SHIFT mode, FIGS. 5 and 7), as a basic reference position for the right thumb, allowing the reflex-based typing and learning of triads of letters n-g-n, n-v-n, n-f-n, n-w-n, n-h-n, n-t-n, n-z-n, in a fashion typical to typing tutor methods and specific to a thumb typing method allowed by the CONVOY keypad design and data entry method (FIGS. 4, 5 and 7);

77. The inclusion of a Vowel Mark key (210) placed symmetrically opposite to the Space Bar (212), the Vowel Mark key being operated by the left thumb and the Space Bar being operated by the right thumb (FIGS. 4, 5 and 7);

78. The symmetrical opposition of the two statistically most frequently used keys in CONVOY data entry, namely the Vowel Mark and the Space bar (210 and 212 of FIGS. 4, 5 and 7);

79. The largest size (three column-wide) allowed to the two statistically most frequently used keys in CONVOY data entry, namely the Vowel Mark and the Space bar (210 and 212 of FIGS. 4, 5 and 7);

80. The most reachable key positions by the thumbs—bottom left and bottom right—allowed to the two statistically most frequently used keys in CONVOY data entry (FIGS. 4, 5 and 7);

81. More frequently used keys are placed opposite to the ALT key (214) when the ALT key is pressed down by the left thumb to activate the ALT mode and/or keypad, allowing their easy input by the right thumb, such as the six vowel keys a, e, i, o, u, y (230); and numeral digits 1, 2, 3, 4, 5, 6, 7, 8, 9 and 0 (232) (FIG. 6);

82. More frequently used keys are placed opposite to the SHIFT key (216) when the SHIFT key is pressed down by the right thumb to activate the SHIFT mode and/or keypad, allowing their easy input by the left thumb, such as the Enter key (222), the Backspace key and the Vowel Mark key (210) (FIG. 5);

83. The use of a generic vowel mark (210) to bring the level of information of a typed word to a level of comprehension or meaning recognizable by most readers and by most word-recognition software (FIGS. 4, 5, 6 and 7).

K. In one example, there is provided a reduction of entered data volume on a hard-keypad operated handheld electronic device by:

84. Omitting some or all vowels in word input and replacing some or all vowels by a generic vowel mark (FIGS. 4, 5, 6 and 7).

L. In one example, the same keypad for a hard-keypad is operated on a handheld electronic device, with an array of keys representing characters of the roman alphabet, numbers, punctuation signs, international Unicode characters and control keys wherein the array includes six columns and six rows and where the default mode (FIG. 4) has thirty-two (32) keys, defined as:

85. (FIG. 4, aa-19 to ff-19) the top row of six keys in default mode identified to and controlling the input of, from left to right, punctuation sign @ known as commercial at, occupying position aa-19 in FIG. 4; punctuation sign . known as period, occupying position bb-19 in FIG. 4; punctuation sign, known as comma, occupying position cc-19 in FIG. 4; punctuation sign; known as semi-colon, occupying position dd-19 in FIG. 4; punctuation sign ? known as interrogation mark, occupying position ee-19 in FIG. 4; punctuation sign ! known as exclamation mark, occupying position ff-19 in FIG. 4.

86. (FIG. 4, key positions aa-20 to ff-20) the second row of six keys in default mode identified to and controlling the input of, from left to right, lower case consonants b, c, d, f, g, h;

87. (FIG. 4, key positions aa-21 to ff-21) the third row of six keys in default mode identified to and controlling the input of, from left to right, lower case consonants j, k, l, m, n, p;

88. (FIG. 4, key positions aa-22 to ff-22) the fourth row of six keys in default mode identified to and controlling the input of, from left to right, lower case consonants q, r, s, t, v, w

89. (FIG. 4, key positions aa-23 to ff-23) the fifth row from the top in default mode, identified to and controlling the input of, from left to right, the ALT mode (key 214) with a occupying position aa-23; position bb-23 in FIG. 4 identified to and controlling the input of punctuation sign \ also known as reverse solidus or backslash symbol; position cc-23 in FIG. 4 identified to and controlling the input of lower case letter X; position dd-23 in FIG. 4 identified to and controlling the input of lower case letter Z; position ee-23 in FIG. 4 identified to and controlling the input of punctuation sign / also known as solidus or slash symbol; and position ff-23 in FIG. 4 identified to and controlling the input of the SHIFT mode (key 216).

90. (FIG. 4, key positions aa-24 to ff-24) the sixth row from the top in default mode, identified to and controlling the input of a ‘vowel mark’ (key 210) with a triple-width key identified as VOWEL MARK and showing the symbol ▪ occupying positions aa-24, bb-24 and cc-24 in FIG. 4; and a triple-width key identified as SPACE BAR (key 212) and controlling the input of single space occupying positions dd-24, ee-24 and cc-24 in FIG. 4.

M. In one example, the same keypad for a hard-keypad is operated on a handheld electronic device wherein the SHIFT mode presents an array of six columns and six rows (FIG. 5) and where the SHIFT mode becomes functional when the SHIFT key (216) is pressed down to activate thirty-two (32) keys in SHIFT mode (FIG. 5) instead of the default mode (FIG. 4) key inputs.

91. (FIG. 5, key positions jj-25 to oo-25) the first row from the top in SHIFT mode having six keys identified to, and controlling the input of, from left to right, a key occupying a single column identified as ENTER (222) and controlling the input of the ENTER function, a key occupying a single column identified to and activating punctuation sign . known as period, a key occupying a single column identified to and activating punctuation sign ' known as apostrophe, a key occupying a single column identified to and activating punctuation sign “ known as quotation mark, a key occupying a single column identified to and activating the input of punctuation sign (known as left parenthesis, a key occupying a single column identified to and activating the input of punctuation sign) known as right parenthesis.

92. (FIG. 5 key positions jj-26 to oo-26) the second row from the top in SHIFT mode having six keys identified to, and controlling the input of, from left to right, upper case consonants B, C, D, F, G, H;

93. (FIG. 5 key positions jj-27 to oo-27) the third row from the top in SHIFT mode identified to, and controlling the input of, from left to right, upper case consonants J, K, L, M, N, P

94. (FIG. 5 key positions jj-28 to oo-28) the fourth row from the top in SHIFT mode identified to, and controlling the input of, from left to right, upper case consonants Q, R, S, T, V, W

95. (FIG. 5 key positions jj-29 to oo-29) the fifth row from the top in SHIFT mode identified to, and controlling the input of, from left to right, a key occupying a single column identified as BCKSPC (220) and controlling the input of the backspace function, a key occupying a single column identified to and controlling the input of punctuation sign * known as asterisk, a key occupying a single column showing punctuation sign “ known as quotation mark and a key occupying two columns identified as SHIFT (216) and controlling the activation of the SHIFT mode keypad (FIG. 5)

96. (FIG. 5 key positions jj-30 to oo-30) the sixth row from the top in SHIFT mode identified to, and controlling the input of, from left to right, a key occupying three columns identified as VOWEL MARK (210) and showing the symbol ▪ and controlling the input of a generic vowel mark and a key occupying three columns identified as SPACE BAR (212) and controlling the input of a single space.

N. In one example, the same keypad for a hard-keypad is operated on a handheld electronic device wherein the array includes six columns and six rows where the ALT mode becomes functional when the ALT key (214) is pressed down and activates thirty-two (32) keys (FIG. 6), namely:

97. (FIG. 6, key positions uu-31 to uu-36) in the sixth column from the left in ALT mode, with six keys identified to, and controlling the input of, from the top row to the bottom row, lower case vowels a, e, i, o, u, y;

98. (FIG. 6, key positions tt-31 to tt-35) in the fifth column from the left in ALT mode, five keys from the top row to the fifth row identified to, and controlling the input of, numbers 3, 6, and 9, the + sign known as ‘plus’, and the − sign known as hyphen or minus sign;

99. (FIG. 6, key positions ss-31 to ss-35) in the fourth column from the left in ALT mode, five keys from the top row to the fifth row, identified to, and controlling the input of numbers 2, 5, 8, 0, and the _ sign known as ‘underscore’;

100. (FIG. 6, key positions rr-31 to rr-35) in the third column from the left in ALT mode, five keys from the top row to the fifth row identified to, and controlling the input of numbers 1, 4 and 7, the = sign known as equals symbol and the : sign known as colon;

101. (FIG. 6, key positions qq-31 to qq-35) in the second column from the left in ALT mode, five keys from the top row to the fifth row identified to, and controlling the input of the % sign known as percent symbol, the HK$ sign known as Hong Kong dollar symbol (or another user-programmable international Unicode character), the ¥ sign known as the Japanese Yen currency symbol (or another user-programmable international Unicode character) and the $ sign known as the dollar currency symbol (or another user-programmable international Unicode character).

102. (FIG. 6, key positions pp-31 to pp-35) in the first column from the left in ALT mode five keys from the top row to the fifth row identified to, and controlling the input of the & sign known as the ampersand, the [symbol] sign known as the Indian rupee currency symbol (or another user-programmable international Unicode character), the [symbol] sign known as the Chinese Yuan currency symbol (or another user-programmable international Unicode character) the [symbol] sign known as the Euro currency symbol (or another user-programmable international Unicode character) and the ALT key activating the ALT keypad (FIG. 6).

103. (FIG. 6, key positions pp-36, qq-36 and rr-36) a triple-width key identified as Vowel Mark (210) and controlling the input of a generic vowel mark.

104. (FIG. 7) a figure showing the markings of all three modes (default, FIG. 4; SHIFT, FIG. 5; and ALT, FIG. 6) on a 32-key hard-keypad for a handheld electronic device as described in above paragraphs 7 to 14.

Referring to FIG. 8, there is illustrated an example of a handheld electronic device for implementing the keyboard distribution illustrated in FIGS. 1-7. The handheld device 800 of FIG. 8 includes a user interface 802, a processor 804, and a storage system 806. The user interface 802 includes an input device 810 and an output device 812. The input device 810 includes, for example, a touch screen keyboard and/or a hard-key keyboard. The input device 810 employs the key distributions of FIGS. 1-3 for a touch screen keyboard or FIGS. 4-7 for a hard-key keyboard. The output device 812 may include a display device, an audio device, a haptic device, or a combination thereof. The processor 804 may be a microprocessor, and may be embedded in a main logic board, and have a memory. The storage system 806 may include a database.

One of ordinary skill in the art would appreciate that the handheld device 800 may include electronics/optics/components/elements not illustrated in the drawings, which may include other components, such as, but not limited to, a speaker, a microphone, a scanner, a volume controller, a visual indicator, a battery component, and a communication interface(s) for wireless and/or wired communications.

The processor 804 includes a plurality of modules including software modules. For example, the processor 804 may include a module 820 for controlling a key distribution mode (default, shift or alt mode), a module 822 for detecting a key position and function based on the user input from the input device 810, and a module (or disambiguation engine) 824 for disambiguating the general vowel mark input from the input device 810. In one example, the modules 820, 822, and 824 are software modules. The module 820, 822, 824 or combinations thereof may be implemented by a DSP.

The storage system 806 may include a look up table for mapping a key position to a specific key distribution (function). The storage system 806 may include a database for storing possible complete words/terms/sentences having a vowel(s). For each object (a combination of at least one consonant and at least one default vowel mark), there may be more than one possible complete words/terms/sentences having a vowel(s).

The possible words/terms/sentences may be updated regularly, for example, via a learning process. The module 824 may learn the typing style and frequently used words/terms/sentences of the user to determine or predict a word/term/sentence having a proper vowel. Other types of predictive text computer programs may be utilized with the reduced keyboard arrangements. The processor 802 may set a priority to each possible complete words/terms/sentence having a vowel(s). The database may be updated via the user inputs or user selections from the input device 810 or the leaning process.

Using the module 824, the inputted words having default vowel marks ▪ are decoded with unique consonant sequence, for example: (th▪mb typ▪ng) to (thumb typing).

In one example, the handheld device 800 may find a possible vowel character for each general vowel mark, and output to the output device 812 a list of terms or sentences having possible vowel characters. The list of terms or sentences having possible vowel characters may be provided using a drop down menu. The user of the handheld device 800 may select one from the list via the input device 810.

In one example, the module 842 may implement unsupervised word disambiguation (i.e., no tag search), supervised word disambiguation or a combination thereof.

The unsupervised word disambiguation decodes words with a unique consonant sequence. The unsupervised word sense disambiguation relies on a machine-readable lexicon—without the need for sense tags to be attached to words. The CONVOY disambiguation software module 842 first looks for all unique word/consonant sequences in a given language, leading to the immediate recognition of the word by the software or reader, with a 100% accuracy. In English, some 25% of words fall under the category of a unique, non-redundant consonant sequence, and can be recognized without any sense tag.

The supervised word disambiguation looks for word clusters and tagged words. A cluster of words usually precedes or follows a punctuation sign or a connecting word. The software module 824 identifies punctuation signs and connecting words, and their preceding/following words—the cluster. A word tag defines the basic nature of the word (noun, pronoun, verb, adverb, adjective, connecting word—and its grammatical relation to other words in the sentence). It can also identify the form and gender: singular form, plural form, masculine and feminine. The software module 842 then decides which spelled-out word best fits the sentence, given the context. In last resort, if words can't be identified, the software module 842 posts the sentence, for example, on screen and the user can replace vowels marks with the appropriate specific vowels manually. An expandable user lexicon can record the word for further reference.

In the above examples, the lower case consonant letters are available in the default mode and the capital consonant letters are available in the shift mode; however, the capital consonant letters may be available in the default mode and the lower case consonant letters may be available in the shift mode. In the above examples, the shift key is used to switch the default mode to the shift mode for providing the capital consonant letters; however, another key, such as, alt key, may be used to switch the default mode to another mode for providing the capital consonant letters. In the above examples, the alt key is used to switch the default mode to the alt mode for providing the vowel letters; however, another key, such as, shift key, may be used to switch the default mode to another mode for providing the vowel letters.

The present invention has been described with regard to one or more embodiments. However, it will be apparent to persons skilled in the art that a number of variations and modifications can be made without departing from the scope of the invention as defined in the claims.

US PATENT SEARCH 1976 to today—Bolean: keypad AND handheld AND vowel

Search all fields

001—U.S. Pat. No. 7,256,769 Pun, et al. Aug. 14, 2007

System and method for text entry on a reduced keyboard

Abstract

A system and method for efficient Asian character text input into a reduced keypad machine such as a word processor, telephone, hand-held computer, or personal computer is provided. The system comprises a data entry keypad associated with a monitor, and a disambiguation process supporting multiple keycap depression timespan range definitions and interpretations to produce accurate messaging with a reduced keypad.

Inventors: Pun; Samuel Yin Lun (Calgary, Calif.), Conrad; John M. (Calgary, Calif.), Paek; Eun-Kyong (Seoul, KR), Xu; Changshi (Calgary, Calif.) Assignee: Zi Corporation of Canada, Inc. (Calgary, Calif.)

Application Ser. No. 10/373,280 Filed: Feb. 24, 2003

002—U.S. Pat. No. 7,312,410 Griffin, et al. Dec. 25, 2007

Reduced qwerty keyboard system that provides better accuracy and associated method

Abstract

A handheld electronic device and an associated method are provided. The handheld electronic device includes a keyboard assembly, a display positioned adjacent the keyboard assembly, a processor structured to receive inputs from the keyboard assembly and to output to the display as a function of the inputs, the processor further structured to run a disambiguation routine. The keyboard assembly includes a printed circuit board, a primary conductor portion, a secondary conductor portion, and a keyboard assembly. The printed circuit board has a plurality of electrical contacts. The conductor assembly has a plurality of primary conductors and a plurality of secondary conductors, each the primary conductor and secondary conductor structured to correspond to, and engage and close, at least one of the plurality of electrical contacts. The keyboard assembly has a plurality of keys each having one or more indicia thereon. The plurality of keys are disposed in a first set of keys and a second set of keys, wherein each key in the first set of keys is coupled to, and structured to engage, a first number of conductors, and, each key in the second set of keys is coupled to, and structured to engage, a second number of conductors wherein the second number is different than the first number.

Inventors: Griffin; Jason (Kitchener, Calif.), Lazaridis; Mihal (Waterloo, Calif.)

Assignee: Research In Motion Limited (Waterloo, Ontario, Calif.)

Application Ser. No. 11/188,307 Filed: Jul. 25, 2005

003—U.S. Pat. No. 7,190,351 Goren Mar. 13, 2007

System and method for data input

Abstract

The invention provides a system and a method for data input that can be used with or incorporated into electronic, computer, and portable devices. The interface includes a small set of control buttons or keys that are used to provide access to an associated set of secondary keys, from which the user can select a character for input into the device. Intelligent ordering and grouping of the control and secondary keys allows the user to input information in a manner conducive to speed, accuracy, and ease of use, while the interface can be minimized to require less real estate than traditional keyboards. In accordance with one embodiment, a set of characters or symbols is divided into subsets, each subset being represented by a control button. Selecting a control button displays a secondary set of buttons representing actual characters or symbols that can be selected, stored, or displayed.

Inventors: Goren; Michael (Niskayuna, N.Y.) Appl. Ser. No.: 0/142,506 filed: May 10, 2002

004—U.S. Pat. No. 7,095,403 Lyustin, et al. Aug. 22, 2006

User interface of a keypad entry system for character input

Abstract

A user interface (102) of a portable electronic device (100) includes a plurality of keys (112). The user interface (102) includes a first group of keys representing vowel characters (402), and a second group of keys representing consonant characters (202). The second group of keys is separate from the first group of keys. For the first group of keys, a first key represents leading vowels (422, 424, 426), a second key represents above and below vowels (428, 430), and a third key represents following vowels (432, 434, 436). The second group of keys may be subdivided into phonetic consonant groups (FIGS. 5 & 6) or alphabetic consonant groups (FIGS. 7 & 8).

Inventors: Lyustin; Victoria (South San Francisco, Calif.), Harman; Robert Michael (Mountain View, Calif.), Ebrahimi; Ali (Half Moon Bay, Calif.) Assignee: Motorola, Inc. (Schaumburg, Ill.) application Ser. No. 10/314,650 Filed: Dec. 9, 2002

005—U.S. Pat. No. 6,724,370 Dutta, et al. Apr. 20, 2004

Touchscreen user interface

Abstract

A customizable touchscreen keyboard, and method, system, and computer program product for customizing the touchscreen keyboard is provided. In one embodiment, a data processing system receives customization characteristics from a user through the touchscreen interface. The data processing system then creates a customized touchscreen keyboard layout based on the customization characteristics and presents the customized touchscreen keyboard layout to a user. For example, the user may customize the keyboard such that the letters are presented in a U-shape with the letters arranged in alphabetical order, thus aiding a user in finding a desired letter. The user may later recustomize the keyboard if desired. Furthermore, the data processing system may reconfigure the keyboard based on past usage by the user.

Inventors: Dutta; Rabindranath (Austin, Tex.), Kamper; Robert J. (Round Rock, Tex.)

Assignee: International Business Machines Corporation (Armonk, N.Y.)

Application Ser. No. 09/833,341 Filed: Apr. 12, 2001

006—U.S. Pat. No. 6,307,548 Flinchem, et al. Oct. 23, 2001

Reduced keyboard disambiguating system

Abstract

A reduced keyboard disambiguating system. The keyboard has twelve to sixteen keys, nine of them labeled with numerous letters and other symbols, and those nine plus one more are associated each with one of the ten digits. Textual entry keystrokes are ambiguous. The user strikes a delimiting “Select” key, or a key with an unambiguous character interpretation, at the end of each word, delimiting a keystroke sequence that could match any of a plurality of words associated with the same keystroke sequence. Each input keystroke sequence is processed with a complete vocabulary, and words which match the sequence of keystrokes are presented to the user in order of decreasing frequency of use. The vocabulary is stored in a special format that supports significant data compression without requiring additional processing. In addition, stems of longer words whose initial letters match the sequence of keystrokes are also presented to the user in order of decreasing frequency of use. If the frequency of the words associated with a stem is high enough, that stem is displayed as the default word object. Activations of an ambiguous key associated with a plurality of punctuation characters are disambiguated from the context of the surrounding keystrokes.

Inventors: Flinchem; Edward P. (Seattle, Wash.), Grover; Dale (Lansing, Mich.), Grunbock; Cheryl (Vashon, Wash.), King; Martin T. (Vashon, Wash.), Kushler; Clifford A. (Lynnwood, Wash.) Assignee: Tegic Communications, Inc. (Seattle, Wash.)

Application Ser. No. 09/160,433 Filed: Sep. 24, 1998

007—U.S. Pat. No. 6,286,064 King, et al. Sep. 4, 2001

Reduced keyboard and method for simultaneous ambiguous and unambiguous text input

Abstract

A reduced keyboard disambiguating system. The keyboard has twelve keys, nine of them labeled with numerous letters and other symbols, and those nine plus one more are labeled each with one of the ten digits. Textual entry keystrokes are ambiguous. The user strikes a delimiting “Select” key at the end of each word, delimiting a keystroke sequence that could match any of many words with the same number of letters. The keystroke sequence is processed with a complete vocabulary, and words which match the sequence of keystrokes are presented to the user in order of decreasing frequency of use. In addition, stems of longer words whose initial letters match the sequence of keystrokes are also presented to the user in order of decreasing frequency of use. The first word in the presented list is automatically selected by the input of the first character in the next word. The letters are assigned to the keys in a non-sequential order which reduces chances of ambiguities. The “Select” key is pressed to select the desired word other than the first word, and spacing between words and punctuation is automatically computed. For words which are not in the vocabulary, a simultaneous unambiguous interpretation of each keystroke is performed to specify each letter of a desired word. The system simultaneously interprets all keystroke sequences as both ambiguous and unambiguous keystrokes. The user selects the desired interpretation. The system also presents to the user the number which is represented by the sequence of keystrokes for possible selection by the user.

Inventors: King; Martin T. (Vashon, Wash.), Grover; Dale L. (Lansing, Mich.), Kushler; Clifford A. (Vashon, Wash.), Grunbock; Cheryl A. (Vashon, Wash.) Assignee: Tegic Communications, Inc. (Seattle, Wash.)

Application Ser. No. 09/339,549 Filed: Jun. 24, 1999

008—U.S. Pat. No. 5,953,541 King, et al. Sep. 14, 1999

Disambiguating system for disambiguating ambiguous input sequences by displaying objects associated with the generated input sequences in the order of decreasing frequency of use

Abstract

A reduced keyboard disambiguating system. The keyboard has twelve keys, nine of them labeled with numerous letters and other symbols, and those nine plus one more are labeled each with one of the ten digits. Textual entry keystrokes are ambiguous. The user strikes a delimiting “Select” key at the end of each word, delimiting a keystroke sequence that could match any of many words with the same number of letters. The keystroke sequence is processed with a complete vocabulary, and words which match the sequence of keystrokes are presented to the user in order of decreasing frequency of use. In addition, stems of longer words whose initial letters match the sequence of keystrokes are also presented to the user in order of decreasing frequency of use. The first word in the presented list is automatically selected by the input of the first character in the next word. The letters are assigned to the keys in a non-sequential order which reduces chances of ambiguities. The “Select” key is pressed to select the desired word other than the first word, and spacing between words and punctuation is automatically computed. For words which are not in the vocabulary, a simultaneous unambiguous interpretation of each keystroke is performed to specify each letter of a desired word. The system simultaneously interprets all keystroke sequences as both ambiguous and unambiguous keystrokes. The user selects the desired interpretation. The system also presents to the user the number which is represented by the sequence of keystrokes for possible selection by the user.

Inventors: King; Martin T. (Vashon, Wash.), Grover; Dale L. (Lansing, Mich.), Kushler; Clifford A. (Vashon, Wash.), Grunbock; Cheryl A. (Vashon, Wash.) Assignee: Tegic Communications, Inc. (Seattle, Wash.)

Application Ser. No. 08/792,969 Filed: Jan. 24, 1997

What is claimed is:

1. A user interface for a handheld computer system comprising:
an input device having a plurality of key positions in a key area and a first key distribution applied to the key positions,
the first key distribution having:
a first group of keys assigned to a first group of the plurality of key positions, associated with a first type of consonant letters in a first mode; and
a second group of keys assigned to a second group of the plurality of key positions, including a vowel mark key for inserting a default mark for a vowel letter.

2. A user interface according to claim 1, comprising:
an output device for outputting a term or sentence having a possible vowel character based on a user's input having the default mark.

3. A user interface according to claim 1, wherein the second group of keys comprises:
at least one first key being capable of switching a current key distribution mode so that a second key distribution is applied to the key area in a second mode.

4. A user interface according to claim 3, wherein the second distribution comprises:
a third group of keys positioned at the first group of keys and associated with a second type of consonant letters.

5. A user interface according to claim 3, wherein the second distribution comprises:
a third group of keys including vowel keys associated with vowel letters, numeral keys associated with numeral letters or combinations thereof.

6. A user interface according to claim 1, wherein the first group of keys are located in a center position in the key area, without any vowel letter keys.

7. A user interface according to claim 6, wherein the first group of keys comprises:
a first consonant letter at a first reference key position, surrounded by a first set of nine consonant letters; and
a second consonant letter at a second reference key position, surrounded by a second set of nine consonant letters.

8. A user interface according to claim 1, wherein each of the first group of keys and the second group of keys are symmetrically distributed about the center vertical axis of the key area.

9. A user interface according to claim 3, wherein each of the first group of keys and the second group of keys are symmetrically distributed about the center vertical axis of the key area.

10. A user interface according to claim 1, wherein two frequently used keys among the second group of keys are distributed symmetrically about the central vertical axis so that one of the two frequency use keys is operated by one thumb and the other is being operated by the other thumb.

11. A user interface according to claim 10, wherein the two frequency used keys include the vowel mark key, a key capable of switching a current key distribution mode or a combination thereof.

12. A user interface according to claim 3, wherein the at least one first key includes a shift key, an alt key or a combination thereof.

13. A user interface according to claim 12, wherein shift mode letters and symbols are located on a first upper side of the key area, and wherein alt mode letters are located on a second upper side of the key area.

14. A user interface according to claim 1, wherein the key area is a square-shaped key area arranged in 6 rows and 6 columns.

15. A user interface according to claim 1, wherein the user interface is implemented with a touch screen or a hard-key keyboard.

16. A user interface for a handheld computer device comprising:
an input device having a plurality of key positions in a key area and a first key distribution applied to the key positions,
the first key distribution having:
a first group of keys assigned to a first group of the plurality of key positions, associated with a first type of consonant letters in alphabetical order, in a first mode, the first group of keys being symmetrically distributed about a center vertical axis of the key area.

17. A user interface according to claim 1, wherein the first group of keys are located in a center position in the key area, without any vowel letter keys.

18. A user interface according to claim 17, wherein the first group of keys comprises:
a first consonant letter at a first reference key position, surrounded by a first set of nine consonant letters; and
a second consonant letter at a second reference key position, surrounded by a second set of nine consonant letters.

19. A user interface according to claim 16, comprising:
a second group of keys assigned to a second group of the plurality of key positions, having a first key being capable of switching a current key distribution mode so that a second key distribution is applied to the key area in the second mode.

20. A user interface according to claim 19, wherein each of the first group of keys and the second group of keys are symmetrically distributed about the center vertical axis of the key area.

21. A user interface according to claim 16, comprising:
a second group of keys assigned to a second group of the plurality of key positions, having a vowel mark key for inserting a default mark for a vowel letter.

22. A user interface according to claim 21, wherein each of the first group of keys and the second group of keys are symmetrically distributed about the center vertical axis of the key area.

23. A user interface according to claim 16, wherein the key area is a square-shaped key area arranged in 6 rows and 6 columns.
